(19) United States
(12) Patent Application Publication
(10) Pub. No.: US 2024/0018013 A1
(43) Pub. Date: Jan. 18, 2024

(54) METHOD FOR PREPARING NICKEL SULFATE FROM FERRONICKEL

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Haijun Yu, Foshan (CN); Yinghao Xie, Foshan (CN); Aixia Li, Foshan (CN); Xuemei Zhang, Foshan (CN); Changdong Li, Foshan (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(21) Appl. No.: 18/374,630

(22) Filed: Sep. 28, 2023

Related U.S. Application Data
(63) Continuation of application No. PCT/CN2022/093097, filed on May 16, 2022.

(30) Foreign Application Priority Data
Aug. 25, 2021 (CN) 202110981602.X

(51) Int. Cl. C01G 53/10; C01G 99/00

(52) U.S. Cl. CPC C01G 53/10; C01G 99/003

(57) ABSTRACT

The present disclosure discloses a method for preparing nickel sulfate from ferronickel, including: S1: in a high-pressure oxygen environment, mixing crushed ferronickel with sulfuric acid, introducing a carbon monoxide gas to allow a reaction, and conducting solid-liquid separation (SLS) to obtain a filtrate and a filter residue; S2: adding an oxidizing agent and a precipitating agent successively to the filtrate, controlling a pH of the filtrate, and conducting SLS to obtain a nickel-containing filtrate and an iron hydroxide precipitate; and S3: subjecting the nickel-containing filtrate to extraction and back-extraction to obtain a nickel sulfate solution. In the present disclosure, the carbon monoxide gas is introduced under high-pressure acidic conditions to first react with nickel and iron to form nickel tetracarbonyl and iron pentacarbonyl, and the nickel tetracarbonyl and iron pentacarbonyl are oxidized by oxygen and then smoothly react with sulfuric acid to form nickel sulfate and iron sulfate.

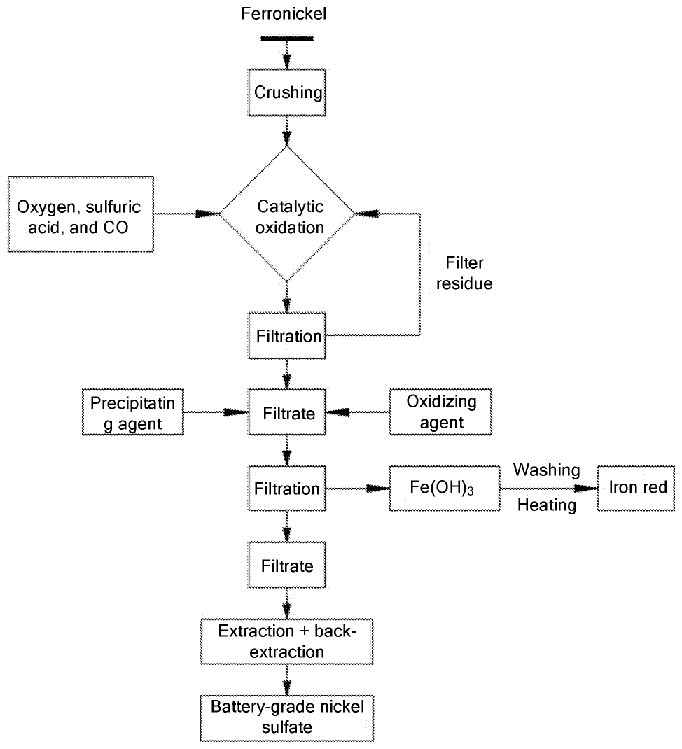

### CROSS-REFERENCE TO RELATED APPLICATIONS

The present application is a continuation application of PCT application No. PCT/CN2022/093097 filed on May 16, 2022, which claims the benefit of Chinese Patent Application No. 202110981602.X filed on Aug. 25, 2021. The contents of all of the aforementioned applications are incorporated by reference herein in their entirety.

### TECHNICAL FIELD

The present disclosure belongs to the technical field of metallurgy, and specifically relates to a method for preparing nickel sulfate from ferronickel.

### BACKGROUND

Nickel is an important non-ferrous metal, and has abundant reserves on the earth. Nickel ores mainly include copper-nickel sulfide ores and nickel oxide ores, and beneficiation and smelting processes for the two are completely different. Different beneficiation methods are adopted according to different grades of copper-nickel sulfide ores, and then smelting is conducted. Smelting and enrichment methods for nickel oxide ores can be divided into two categories: fire process and wet process.

With the rapid growth in the global production and sales of new energy vehicles, a proportion of ternary power batteries is increasing, and the high-nickel technology route has become an industry consensus. Under the combined action of the above factors, the nickel sulfate consumption in the power battery field will definitely experience rapid growth in the future.

In a traditional nickel sulfate production process, a nickel sulfide ore is subjected to pyrometallurgical smelting to produce nickel matte, and then a wet process is adopted to produce nickel sulfate. However, at present, nickel sulfide ores have small reserves, require relatively high mining conditions, and has a declined ore grade, which leads to a gradual decline in the output of nickel sulfide ores. Under the background of insufficient nickel sulfide ore resources, a new process needs to be developed to make the supply of nickel laterite ores with great resource potential match with the accelerated growth of nickel sulfate demand.

At present, a process for producing a nickel product from a nickel laterite ore mainly includes two types: fire process and wet process. The fire process includes a rotary kiln-electric furnace (RKEF) reduction smelting process, a shaft furnace-electric furnace reduction smelting process (NST), Dajiangshan smelting process, and a rotary hearth furnace (RHF) process that has not yet been industrialized. Due to high yield, the RKEF fire process has been widely used in recent years, and a nickel product produced by the process is ferronickel with various impurities.

Industrially, ferronickel is commonly mixed with a sulfur-containing material and then subjected to converter blowing to produce nickel matte, and then a wet process is adopted to produce nickel sulfate. In this method, nickel matte needs to be first prepared from ferronickel, and then nickel sulfate is prepared through leaching, which involves long process flow, high raw material consumption, high investment cost, and low nickel yield in the preparation of nickel sulfate by the wet process.

In the prior art, some related manufacturers also use ferronickel to directly prepare nickel sulfate as follows: ferronickel is allowed to react with sulfuric acid and nitric acid to obtain a solution, and then gradual purification is conducted to prepare nickel sulfate. The process is complicated, requires high extracting agent and precipitating agent consumption, releases the toxic gas of nitric oxide during a reaction, and cannot achieve the purpose of clean production.

The related art discloses a method for selectively separating valuable metals in a cobalt-nickel-copper-iron alloy, where the cobalt-nickel-copper-iron alloy is melted at 1,300° C. to 1,600° C., and then atomized and powdered by a high-pressure atomization device to obtain a cobalt-nickel-copper-iron alloy powder; the alloy powder is added to a sulfuric acid system, and an oxidizing gas or an oxidizing agent was introduced, where a flow rate of the gas or an amount of the oxidizing agent added is adjusted to achieve potential-controlled selective leaching to obtain a Cu residue and a mixed leachate with Co, Ni, and Fe; the Cu residue is further subjected to enhanced oxidation leaching and purification to obtain a Cu chemical; and the mixed leachate with Co, Ni, and Fe is added to a specially-designed corrosion leaching tank for corrosion separation to obtain a mixed solution of an iron rust residue, nickel sulfate, and cobalt sulfate. The preparation method is novel and pollution-free, and involves a short process. However, the pretreatment stage requires high-temperature melting and then atomization and powdering, which requires high energy consumption and is difficult to achieve industrialization.

Therefore, there is an urgent need to develop a method for directly preparing nickel sulfate from ferronickel in one step, with short process, low cost, and high yield.

### SUMMARY OF THE INVENTION

The present disclosure is intended to solve at least one of the technical problems existing in the prior art. In view of this, the present disclosure provides a method for preparing nickel sulfate from ferronickel. The method can lead to battery-grade nickel sulfate, and has the advantages of short process, low auxiliary material consumption, high nickel yield, and the like.

According to one aspect of the present disclosure, a method for preparing nickel sulfate from ferronickel is provided, including the following steps:

S1: in a high-pressure oxygen environment, mixing crushed ferronickel with sulfuric acid, introducing a carbon monoxide gas to allow a reaction, and conducting solid-liquid separation (SLS) to obtain a filtrate and a filter residue;

S2: adding an oxidizing agent to the filtrate, and then adding a precipitating agent, controlling a pH of the filtrate, and conducting SLS to obtain a nickel-containing filtrate and an iron hydroxide precipitate; and

S3: subjecting the nickel-containing filtrate to extraction and back-extraction to obtain a nickel sulfate solution.

In some implementations of the present disclosure, in S1, the reaction may be conducted in a closed space, the carbon monoxide gas may be introduced through a bottom of the crushed ferronickel, and a volume concentration of the carbon monoxide gas in the closed space may be controlled at ≤2.5%. The concentration and introduction mode of the carbon monoxide gas in the closed environment are controlled to prevent flash explosions and avoid safety accidents.

In some implementations of the present disclosure, in S1, the reaction may be conducted at 40° C. to 200° C. The reaction temperature is controlled such that the carbon monoxide gas can react with the ferronickel to achieve a rapid decomposition and oxidation, which is a catalytic oxidation.

In some implementations of the present disclosure, in S1, the sulfuric acid may have a concentration of 3 mol/L to 8 mol/L. Since nickel tetracarbonyl is prone to an explosion reaction with concentrated sulfuric acid, the concentration of sulfuric acid needs to be controlled.

In some implementations of the present disclosure, in S1, the reaction may be conducted at a pressure of 3.0 MPa to 6.5 MPa. Under this pressure condition, the oxidation reaction can be accelerated.

In some implementations of the present disclosure, in S1,the filter residue can be returned to the previous procedure to further react, thereby avoiding waste of materials.

In some implementations of the present disclosure, in S2, the oxidizing agent may be one or more from the group consisting of hydrogen peroxide, compressed air, chlorine, and sodium chlorate. The oxidizing agent oxidizes ferrous iron in the filtrate to facilitate subsequent precipitation.

In some implementations of the present disclosure, in S2, the precipitating agent may be one or more from the group consisting of ammonia water, sodium hydroxide, sodium carbonate, and sodium bicarbonate.

In some implementations of the present disclosure, in S2, the pH may be 3 to 3.5. At this pH, iron hydroxide can be completely precipitated, and nickel ions can be retained.

In some implementations of the present disclosure, in S2, the iron hydroxide can be washed and heated to produce iron red.

In some implementations of the present disclosure, in S3, a process of the extraction and back-extraction may include: adding an extracting agent to the nickel-containing filtrate for nickel extraction to obtain a nickel-containing organic phase, and adding a sulfuric acid solution to the nickel-containing organic phase for nickel back-extraction to obtain the nickel sulfate solution.

In some implementations of the present disclosure, in S3, the extracting agent may be one or more from the group consisting of P204, P507, DEHPA, and Cyanex272.

In some implementations of the present disclosure, in S3, an organic phase obtained after the back-extraction can be re-saponified and recycled.

According to a preferred implementation of the present disclosure, the present disclosure at least has the following beneficial effects:

In the present disclosure, the carbon monoxide gas is introduced under high-pressure acidic conditions to first react with nickel in ferronickel to form nickel tetracarbonyl, and the nickel tetracarbonyl is oxidized by oxygen and then smoothly reacts with sulfuric acid to form nickel sulfate, which promotes the leaching of nickel through catalytic oxidation. The method involves a relatively rapid reaction process and a short process flow, and can prepare battery-grade nickel sulfate directly from ferronickel in a closed environment such that no toxic gas is released and environmental pollution is avoided, which greatly improves a nickel yield, reduces an investment cost, has low energy and auxiliary material consumption, and is suitable for industrialized production.

### BRIEF DESCRIPTION OF THE DRAWINGS

The present disclosure is further described below with reference to accompanying drawings and examples.

The sole FIGURE is a schematic diagram illustrating a process flow of Example 1 of the present disclosure.

### DETAILED DESCRIPTION OF ILLUSTRATED EXAMPLES

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### EXAMPLE 1

In this example, nickel sulfate was prepared from ferronickel. The ferronickel had the following composition: nickel: 16.79%, iron: 75.10%, silicon: 1.96%, carbon: 1.46%, sulfur: and chromium: 0.24%. As shown in the sole figure, a specific preparation process was as follows:
(1) Raw material pretreatment: 100 g of ferronickel was crushed into a powdery or granular material.
(2) Catalytic oxidation: In a closed high-pressure oxygen environment, the crushed material obtained in step (1) was subjected to acid-leaching with sulfuric acid, and a carbon monoxide gas was introduced from a bottom of the crushed material to catalyze a reaction, where a volume concentration of the carbon monoxide gas in the closed space was controlled at ≤2.5%, the reaction was conducted at 40° C. to 50° C. and 6.5 Mpa for 3.5 h, and the sulfuric acid had a concentration of 3 mol/L.
(3) Filtration: After the reaction in step (2) was completed, SLS was conducted to obtain a filtrate and a filter residue.
(4) Precipitation: Hydrogen peroxide was added to the filtrate obtained in step (3) to oxidize ferrous iron in the filtrate, then ammonia water was added, and a pH of the filtrate was controlled at 3 to 3.5; and a resulting mixture was filtered to obtain a nickel-containing filtrate and an iron hydroxide precipitate, and the iron hydroxide precipitate was washed and heated to obtain iron red.
(5) Extraction: An extracting agent P204 was added to the nickel-containing filtrate collected in step (4) for nickel extraction, a resulting mixture was settled into layers, and the layers were separated to obtain a nickel-containing organic phase and an impurity-containing raffinate.
(6) Back-extraction: A 3 mol/L H₂SO₄ solution was added to the nickel-containing organic phase obtained in step (5) for nickel back-extraction to obtain a battery-grade nickel sulfate solution.

As determined, 71.32 g of iron red (calculated based on iron) and 16.73 g of nickel sulfate (calculated based on nickel) were obtained, indicating an iron leaching rate of 94.97% and a nickel leaching rate of 99.64%.

### EXAMPLE 2

In this example, nickel sulfate was prepared from ferronickel. The ferronickel had the following composition: nickel: 18.22%, iron: 72.03%, silicon: 1.85%, carbon: 1.41%, sulfur: 0.362%, and chromium: 0.12%. A specific preparation process was as follows:
(1) Raw material pretreatment: 100 g of ferronickel was crushed into a powdery or granular material.
(2) Catalytic oxidation: In a closed high-pressure oxygen environment, the crushed material obtained in step (1) was subjected to acid-leaching with sulfuric acid, and a carbon monoxide gas was introduced from a bottom of the crushed material to catalyze a reaction, where a volume concentration of the carbon monoxide gas in the closed space was controlled at ≤2.5%, the reaction was conducted at 100° C. to 120° C. and 4.5 Mpa for 2.5 h, and the sulfuric acid had a concentration of 8 mol/L.
(3) Filtration: After the reaction in step (2) was completed, SLS was conducted to obtain a filtrate and a filter residue.
(4) Precipitation: Chlorine was introduced into the filtrate obtained in step (3) to oxidize ferrous iron in the filtrate, then sodium hydroxide was added, and a pH of the filtrate was controlled at 3 to 3.5; and a resulting mixture was filtered to obtain a nickel-containing filtrate and an iron hydroxide precipitate, and the iron hydroxide precipitate was washed and heated to obtain iron red.
(5) Extraction: An extracting agent P507 was added to the nickel-containing filtrate collected in step (4) for nickel extraction, a resulting mixture was settled into layers, and the layers were separated to obtain a nickel-containing organic phase and an impurity-containing raffinate.
(6) Back-extraction: A 4 mol/L H₂SO₄ solution was added to the nickel-containing organic phase obtained in step (5) for nickel back-extraction to obtain a battery-grade nickel sulfate solution.

As determined, 65.47 g of iron red (calculated based on iron) and 18.10 g of nickel sulfate (calculated based on nickel) were obtained, indicating an iron leaching rate of 90.89% and a nickel leaching rate of 99.34%.

### EXAMPLE 3

In this example, nickel sulfate was prepared from ferronickel. The ferronickel had the following composition: nickel: 18.77%, iron: 71.65%, silicon: 0.94%, carbon: 2.21%, sulfur: 0.136%, and chromium: 0.61%. A specific preparation process was as follows:

(1) Raw material pretreatment: 100 g of ferronickel was crushed into a powdery or granular material.

(2) Catalytic oxidation: In a closed high-pressure oxygen environment, the crushed material obtained in step (1) was subjected to acid-leaching with sulfuric acid, and a carbon monoxide gas was introduced from a bottom of the crushed material to catalyze a reaction, where a volume concentration of the carbon monoxide gas in the closed space was controlled at <2.5%, the reaction was conducted at 150° C. to 200° C. and 3 Mpa for 1 h, and the sulfuric acid had a concentration of 5 mol/L.

(3) Filtration: After the reaction in step (2) was completed, SLS was conducted to obtain a filtrate and a filter residue.

(4) Precipitation: Sodium chlorate was added to the filtrate obtained in step (3) to oxidize ferrous iron in the filtrate, then sodium carbonate was added, and a pH of the filtrate was controlled at 3 to 3.5; and a resulting mixture was filtered to obtain a nickel-containing filtrate and an iron hydroxide precipitate, and the iron hydroxide precipitate was washed and heated to obtain iron red.

(5) Extraction: An extracting agent DEHPA was added to the nickel-containing filtrate collected in step (4) for nickel extraction, a resulting mixture was settled into layers, and the layers were separated to obtain a nickel-containing organic phase and an impurity-containing raffinate.

(6) Back-extraction: A 5 mol/L H2504 solution was added to the nickel-containing organic phase obtained in step (5) for nickel back-extraction to obtain a battery-grade nickel sulfate solution.

As determined, 66.72 g of iron red (calculated based on iron) and 18.65 g of nickel sulfate (calculated based on nickel) were obtained, indicating an iron leaching rate of 93.12% and a nickel leaching rate of 99.36%.

The present disclosure is described in detail with reference to the accompanying drawings and examples, but the present disclosure is not limited to the above examples. Within the scope of knowledge possessed by those of ordinary skill in the technical field, various changes can also be made without departing from the purpose of the present disclosure. In addition, the examples in the present disclosure or features in the examples may be combined with each other in a non-conflicting situation.

Claims:

1. A method for preparing nickel sulfate from ferronickel, comprising the following steps:
S1: in a high-pressure oxygen environment, mixing crushed ferronickel with sulfuric acid, introducing a carbon monoxide gas to allow a reaction, and conducting solid-liquid separation to obtain a filtrate and a filter residue, the reaction is conducted in a closed space, the carbon monoxide gas is introduced through a bottom of the crushed ferronickel, and a volume concentration of the carbon monoxide gas in the closed space is controlled at ≤2.5%; the reaction is conducted at 40° C. to 200° C.; the sulfuric acid has a concentration of 3 mol/L to 8 mol/L;
S2:adding an oxidizing agent to the filtrate, and then adding a precipitating agent, controlling a pH of the filtrate, and conducting solid-liquid separation to obtain a nickel-containing filtrate and an iron hydroxide precipitate; and
S3: subjecting the nickel-containing filtrate to extraction and back-extraction to obtain a nickel sulfate solution; a process of the extraction and back-extraction comprises: adding an extracting agent to the nickel-containing filtrate for nickel extraction to obtain a nickel-containing organic phase, and adding a sulfuric acid solution to the nickel-containing organic phase for nickel back-extraction to obtain the nickel sulfate solution; the extracting agent is one or more selected from the group consisting of P204, P507, DEHPA, and Cyanex272.

2. The method according to claim 1, wherein in S1, the reaction is conducted at a pressure of 3.0 MPa to 6.5 MPa.

3. The method according to claim 1, wherein in S2, the oxidizing agent is one or more selected from the group consisting of hydrogen peroxide, compressed air, chlorine, and sodium chlorate.

4. The method according to claim 1, wherein in S2, the precipitating agent is one or more selected from the group consisting of ammonia water, sodium hydroxide, sodium carbonate, and sodium bicarbonate.

5. The method according to claim 1, wherein in S2, the pH is 3 to 3.5.
